(19) United States
(12) Patent Application Publication
(10) Pub. No.: US 2010/0062178 A1
(43) Pub. Date: Mar. 11, 2010

(54) Apparatus and method for fabricating one-dimensional nanostructures on flexible substrates

(76) Inventors: Ruth Yu-Ai Y. Zhang, Gilbert, AZ (US); George N. Maracas, Phoenix, AZ (US); Larry A. Nagahara, Phoenix, AZ (US)

Correspondence Address: INGRASSIA FISHER & LORENZ, P.C. (MOT), 7010 E. Cochise Road, SCOTTSDALE, AZ, 85253, US

(21) Appl. No.: 11/603,558

(22) Filed: Nov. 20, 2006

(51) Int. Cl. B05D 3/06

(52) U.S. Cl. 427/553; 118/46

(57) ABSTRACT

An apparatus and method are provided for forming one dimensional nanostructures. The method comprises ink jet printing (52) a plurality of catalyst particles (36) on a substrate (32). A gas (20) is applied (54) to the catalyst particles (36) while simultaneously applying (56) microwave radiation (38).

### FIELD OF THE INVENTION

The present invention generally relates to an apparatus and method for forming one-dimensional nanostructures and more particularly to growing carbon nanotubes on a flexible substrate.

### BACKGROUND OF THE INVENTION

One-dimensional nanostructures, such as belts, rods, tubes and wires, have become the latest focus of intensive research with their own unique applications. One-dimensional nanostructures are model systems to investigate the dependence of electrical and thermal transport or mechanical properties as a function of size reduction. In contrast with zero-dimensional nanostructures, such as quantum dots, and two-dimensional nanostructures, (e.g., GaAs/AlGaAs superlattice) direct synthesis and growth of one-dimensional nanostructures has been relatively slow due to difficulties associated with controlling the chemical composition, dimensions, and morphology.

Carbon nanotubes are one of the most important species of one-dimensional nanostructures. Carbon nanotubes are one of four unique crystalline structures for carbon, the other three being diamond, graphite, and fullerene. In particular, carbon nanotubes refer to a helical tubular structure grown with a single wall (single-walled nanotubes) or multiple wall (multi-walled nanotubes). These types of structures are obtained by rolling a sheet formed of a plurality of hexagons. The sheet is formed by combining each carbon atom thereof with three neighboring carbon atoms to form a helical tube. Carbon nanotubes typically have a diameter on the order of a fraction of a nanometer to a few hundred nanometers. As used herein, a “carbon nanotube” is any elongated carbon structure.

Another class of one-dimensional nanostructures is nanowires. Nanowires of inorganic materials have been grown from metal (e.g., Ag and Au), elemental semiconductors (e.g., Si, and Ge), III-V semiconductors (e.g., GaAs, GaN, GaP, InAs, and InP), II-VI semiconductors (e.g., CdS, CdSe, ZnS, and ZnSe) and oxides (e.g., SiO₂ and ZnO). Similar to carbon nanotubes, inorganic nanowires can be synthesized with various diameters and length, depending on the synthesis technique and/or desired application needs.

Both carbon nanotubes and inorganic nanowires have been demonstrated as field effect transistors (FETs) and other basic components in nanoscale electronics such as p-n junctions, bipolar junction transistors, inverters, etc. The motivation behind the development of such nanoscale components is that “bottom-up” approach to nanoelectronics has the potential to go beyond the limits of the traditional “top-down” manufacturing techniques.

Organic semiconductors using small molecules or polymers have become attractive materials for the fabrication of low cost electronic devices on flexible substrates using ink-jet technology. Field effect transistors have been demonstrated using these organic materials as conducting channels. The performance of organic field effect transistors is generally poor due to the carrier's low mobility. Single-walled carbon nanotubes are one of the most actively studied novel materials for nano-electronic applications. The excellent transport and mechanical properties of nanotubes make them a potential candidate for the low-cost, high performance devices fabricated on flexible substrates. However, preparation of nanotubes ink from bulk grown nanotubes presents issues since the raw material always contains a certain percentage of amorphous carbonaceous materials and catalyst particles. Chemical vapor deposition processes have been used to grow high quality single walled carbon nanotubes with a higher percentage of semiconducting nanotubes that is desired for the fabrication of nanotube based field effect transistors and sensors. The diameter of chemical vapor deposition grown nanotubes can be controlled by the catalyst particle size. But most of the flexible substrates can not survive the high temperature involved in conventional chemical vapor deposition processes.

Accordingly, it is desirable to provide an apparatus and method for forming one dimensional nanostructures at low temperatures. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

An apparatus and method are provided for forming one dimensional nanostructures which are amenable for direct growth at low temperature on flexible substrates. The method comprises ink jet printing a plurality of catalyst particles on a substrate. A gas is applied to the catalyst particles while simultaneously and locally applying microwave radiation which heats the catalyst particles thereby initiating one-dimensional nanostructure growth.

### BRIEF DESCRIPTION OF THE DRAWINGS

The present invention will hereinafter be described in conjunction with the following drawing figures, wherein like numerals denote like elements, and

FIG. 1 is a schematic view of an apparatus of a first exemplary embodiment;

FIG. 2 is a schematic view of an apparatus of a second exemplary embodiment;

FIG. 3 is a schematic view of an apparatus of a third exemplary embodiment; and

FIG. 4 is a flow chart of the method in accordance with each of the described embodiments.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

One dimensional nanostructures such as nanotubes and nanowires show promise for the development of molecular-scale sensors, resonators, field emission displays, and logic/memory elements. One dimensional nanostructures are herein defined as a material having a high aspect ratio of greater than 10 to 1 (length to diameter), and include carbon nanotubes, nanowires, and carbon nanowires.

A growth technique is disclosed wherein one dimensional nanostructures are grown on, for example, a flexible substrate. Catalyst particles are prepared in liquid form and printed in desired locations on the substrate, e.g., using an ink jet printing technique. The one dimensional nanostructures are then grown in a chemical vapor deposition process using microwaves to supply heat. Alternatively, the one dimensional nanostructures may be grown in a microwave oven containing carbon precursors. Microwaves will selectively heat the catalyst particles without damaging the substrate. A thermal insulating material such as PVP (polyvinyl pyrrolidone, povidone, or polyvidone) may also be printed on the substrate to minimize heat transfer from the catalyst to the substrate.

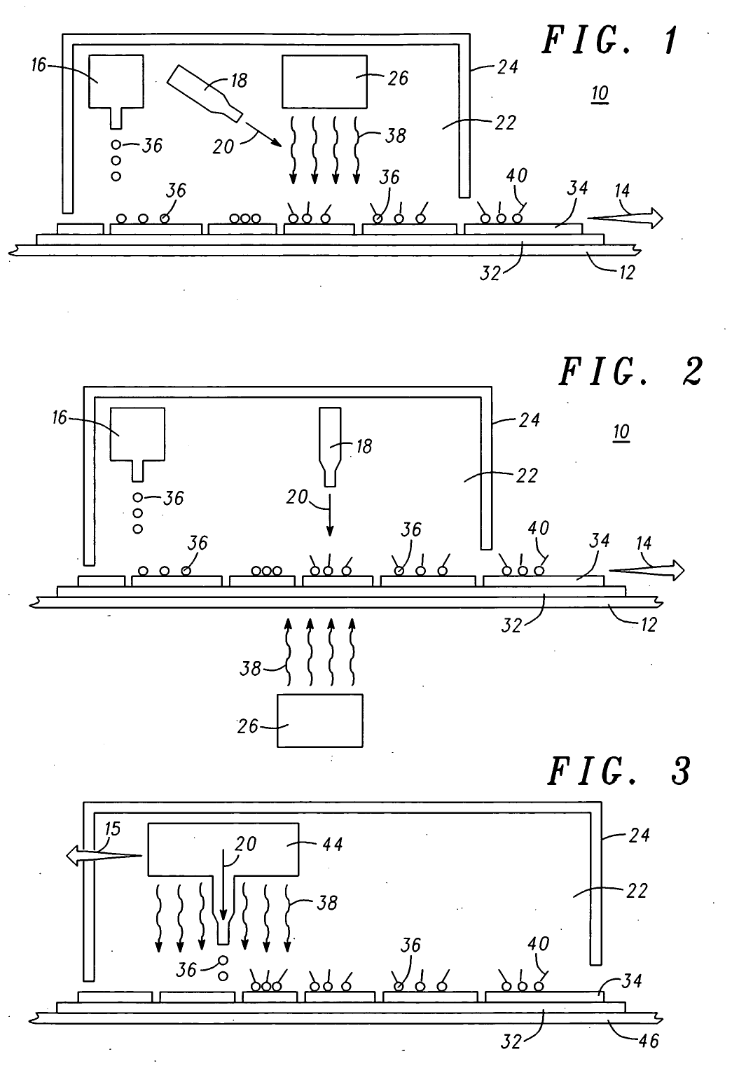

Though the present invention may be applied to nanostructures as defined herein, the exemplary embodiment illustrates the treatment of carbon nanotubes; however, the invention should not be limited to carbon nanotubes. Referring now to FIG. 1, illustrated in simplified cross-sectional views, is an assembled structure utilized for growth of carbon nanotubes according to an exemplary embodiment of the present invention.

Referring to FIG. 1, an apparatus 10 of a first exemplary embodiment comprises a moving belt 12, e.g., sometimes referred to as a conveyor belt, that moves in the direction represented by the arrow 14. An ink jet printer 16 is positioned near, but spaced apart from the moving belt 12, preferably in the range of 0.1 to 5.0 centimeters. Though the preferred embodiment describes the use of the ink jet printer 16, any type of printing technique could be used. A device 18 supplies a gas represented by the arrow 20. The device alternatively may comprise an inlet (not shown) into the chamber 22 surrounded by the housing 24, which provides a controllable environment. A microwave apparatus 26 is positioned near, but spaced apart from the moving belt 12, preferably in the range of 0.01 meters to 1.0 meter.

With the belt 12 moving in the direction 14, a substrate 32 positioned on the belt 12 moves in the direction 14. An optional conductive layer 34 may be positioned on the substrate. The ink jet printer 16 applies catalyst particles 36 onto the conductive layer 34 as it passes the ink jet printer 16. The catalyst particles 36 are exposed to the gas 20 supplied by the device 18 and microwaves 38 are applied simultaneously to grow one-dimensional nanostructures 40 from the catalyst particles 36. The speed of the moving belt 12 preferably is in the range of 0.1 micrometer to 1.0 centimeter per second; however, the speed may vary depending on, e.g., the size of the catalyst particles 36, density of the gas 20, and the intensity of the microwaves 38.

The substrate 32 may alternatively be coated with an insulating material (not shown). The substrate 32 comprises any semiconductor material well known in the art, for example, silicon (Si), gallium arsenide (GaAs), germanium (Ge), silicon carbide (SiC), indium arsenide (InAs), or the like, but may comprise a flexible substrate made of polymers such as a Teflon sheet. The optional insulating material (not shown) may comprise any material that provides insulative properties such silicon oxide (SiO₂), silicon nitride (SiN), or the like. The insulating material 18 comprises a thickness of between 2 nanometers and 10 microns. The substrate 32 and insulating material (not shown) form substrate 32 as illustrated in the FIGS. It should be understood that anticipated by this disclosure is an alternate embodiment in which the substrate 32 is formed as a single layer of insulating material, such as glass, plastic, ceramic, or any dielectric material that would provide insulating properties.

In this exemplary embodiment, the patterned conductive layer 34 formed on an uppermost surface of the substrate 32 is formed using any form of lithography, for example, ink jet printing, photolithography, electron beam lithography, and imprint lithography on the substrate 32 to provide addressable traces for groups of the one-dimensional nanostructures 40. In some embodiments, the conductive layer 34 may comprise highly doped semiconductor material, but preferably comprises a metal such as copper or gold. The conductive layer 34 comprises a thickness in the range of 1 nanometer to 5000 nanometers.

The catalyst nanoparticles 36 may comprise any known catalyst material know for growing one-dimensional nanostructures 40, however preferably comprise nickel or cobalt for ink jet printing. Ink jet printing of the catalyst provides many advantages. First, the placement of the catalyst nanoparticles 36 may be accurately determined. Second, only the required amount of ink/catalyst is utilized. Third, the pattern may be adjusted as desired by manipulation of a nozzle on the ink jet printer 26. Fourth, the ink/catalyst nanoparticles 36 may be applied to any substrate, including flexible substrates and organic polymer materials.

The preparation of the ink/catalyst nanoparticles 36 involves stabilizing a small amount of solvent containing, e.g., cobalt ions with a surfactant (didecyldimethylammonium bromide) and then chemically reducing with sodium borohydride. The cobalt nanoparticles may then be purified by evaporating toluene solvent, adding an excess amount of ethanol, decantation, and redispersion in toluene with a small amount of pyridine.

After catalytic nanoparticles 36 positioning, one dimensional nanotubes 40 are grown from the catalytic nanoparticles 36 by applying, e.g., a gas comprising carbon for carbon nanotube growth. Simultaneously, microwaves 40 are applied to heat the catalytic nanoparticles 36. Microwave energy is absorbed by the catalyst nanoparticles 36 through molecular interactions with the electromagnetic field, providing uniform, rapid, and volumetric heating. Heating the substrate may be avoided by selection of materials, wherein the catalyst nanoparticles 36 absorb the microwaves 38, while the substrate 32 does not. Furthermore, the microwaves 38 may be prevented from reaching the substrate 32 by forming the insulative layer 33 (FIG. 3) over the substrate. The microwaves 38 may comprise energy in the range of a few hundred milliwatts to a few hundred watts, and would be applied for at least one second up to about one minute. Although only a few catalytic nanoparticles 36 and carbon nanotubes 40 are shown, those skilled in the art understand that any number of catalytic nanoparticles 36 and carbon nanotubes 40 could be formed. It should further be noted that the conductive layer 34 may be formed either before or after the formation of the carbon nanotubes 40. Furthermore, in yet another embodiment, the conductive layer 34 may be omitted altogether.

The semiconductor nanostructures 40 may be prepared, for example, as a field effect transistor for use in sensors or electronic circuits, or as conductive elements, in which case a carbon nanotube 40 will be grown from one catalytic nanoparticle 36 to an electrode or to another carbon nanotube 40 to form a electrical connection between traces of the conductive layer 34.

When used for a display device, the carbon nanotubes 40 may be grown in a vertical direction. It should be understood that any one dimensional nanostructure having a height to radius ratio of greater than 10, for example, would function equally well with some embodiments of the present invention.

The process preferably may be conducted with a microwave frequency of 0.5 to 500.0 GHz, although the frequency range may be much larger, and for generally less than one minute.

A second exemplary embodiment is shown in FIG. 2 wherein the microwave apparatus 26 is positioned below the moving belt 12 in a position relatively opposed to the device 18 that supplies the gas. A third exemplary embodiment is shown in FIG. 3 wherein ink jet printer 16, gas device 18, and the microwave apparatus 26 comprise a combined ink jet printer, gas dispenser, and microwave apparatus 44 that moves in the direction 15. The substrate 32 rests on a stable platform 46. A thermal insulating material 48 such as PVP may be formed, e.g., printed, on the substrate 32 to minimize heat transferring from the catalyst nanoparticles 36 to the substrate 32. Alternatively, the catalyst nanoparticles 36 and gas 20 may comprise a mixture of gas or liquid carbon pre-cursor with catalyst particles such as an ethanol/ferrocene material.

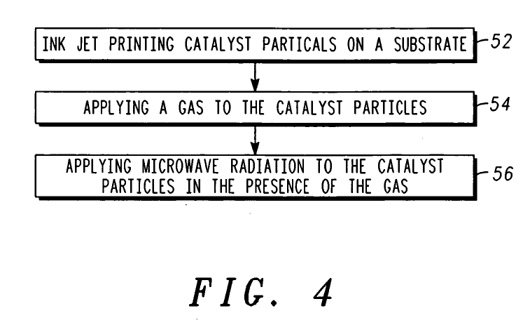

The process is further illustrated by the flow chart in FIG. 4 wherein catalyst particles 36 are ink jet printed 52 on a substrate 32. A gas 20 is applied 54 to the catalyst particles 36 while simultaneously applying 56 microwave radiation 38.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. An apparatus defining a chamber for growing one-dimensional nanostructures, comprising:
a belt for positioning a substrate thereon;
a printer spatially positioned from the belt and within the chamber;
a device for providing a gas into the chamber; and
a microwave device spatially positioned from the moveable belt.

2. The apparatus of claim 1 wherein the printer comprises an ink jet printer.

3. The apparatus of claim 2 wherein the ink jet printer is spaced from the moveable belt by a distance in the range of 0.1 to 5.0 centimeters.

4. The apparatus of claim 2 wherein the microwave device is spaced from the moveable belt by a distance in the range of 0.01 meters to 1.0 meter.

5. The apparatus of claim 2 wherein one of the belt or the ink jet printer and the device for providing a gas move in relation to the other.

6. An apparatus for growing one-dimensional nanostructures, comprising:
a platform for positioning a substrate thereon;
a printer for ink jet printing catalyst particles onto the substrate;
a device providing a gas to the catalyst particles; and
a device providing microwaves to the catalyst particles for growing the one-dimensional nanostructures, wherein one of the platform, or the printer and the device providing microwaves moves in relation to the other.

7. A method of growing one-dimensional nanostructures on a substrate, comprising:
printing catalyst particles on the substrate;
applying a gas to the catalyst particles; and
applying microwave radiation to the catalyst particles for growing the one-dimensional nanostructures.

8. The method of claim 7 wherein the printing step comprises ink jet printing.

9. The method of claim 8 wherein the printing step comprises ink jet printing on a flexible substrate.

10. The method of claim 8 wherein the printing step comprises patterning catalyst particles on the substrate.

11. The method of claim 8 further comprising applying a conductive layer between the substrate and the catalyst particles.

12. The method of claim 8 wherein the applying microwave radiation comprises heating the catalyst particles substantially more than the substrate.

13. The method of claim 8 wherein the applying microwave radiation comprises growing one-dimensional nanostructures.

14. The method of claim 8 wherein the printing step comprises applying a formulated catalyst solution having viscosity of less than 2.0 cP.

15. The method of claim 8 wherein the printing step comprises applying a formulated catalyst solution having viscosity of less than 100.0 cP.

16. A method of growing carbon nanostructures on a substrate within a chamber, comprising:
formulating a catalyst solution having a viscosity of less than 100.0 cP;
ink jet printing the catalyst particles on the substrate;
applying a gas comprising carbon and hydrogen to the catalyst particles; and
applying microwave radiation to the catalyst particles to grow the carbon nanostructures.

17. The method of claim 16 wherein the printing step comprises ink jet printing on a flexible substrate.

18. The method of claim 16 further comprising applying a conductive layer between the substrate and the catalyst particles.

19. The method of claim 16 wherein the applying microwave radiation comprises heating the catalyst particles substantially more than the substrate.

20. The method of claim 16 wherein the applying microwave radiation comprises growing one-dimensional nanostructures.

21. The method of claim 16 wherein the printing step comprises applying a formulated catalyst solution having viscosity of less than 2.0 cP.

22. The method of claim 16 wherein the printing step comprises applying a formulated catalyst solution having viscosity of less than 100.0 cP
